(19) United States
(12) Patent Application Publication
(10) Pub. No.: US 2025/0170525 A1
(43) Pub. Date: May 29, 2025

(54) ISOLATION OF CARBON DIOXIDE USING A HALOGEN GAS

(71) Applicant: AEON BLUE TECHNOLOGIES, INC., Austin, TX (US)

(72) Inventor: Deóis Chiaráin Mac Séamuis Ua Cearnaigh, Toronto (CA)

(21) Appl. No.: 18/839,917

(22) PCT Filed: Feb. 22, 2023
(86) PCT No.: PCT/US2023/063076

§ 371 Date: Aug. 20, 2024

Related U.S. Application Data
(60) Provisional application No. 63/313,044, filed on Feb. 23, 2022.
(60) Provisional application No. 63/319,163, filed on Mar. 11, 2022.
(60) Provisional application No. 63/326,584, filed on Apr. 1, 2022.

(51) Int. Cl. B01D 53/62; B01D 53/77

(52) U.S. Cl. CPC B01D 53/62; B01D 53/77; B01D 2251/108; B01D 2251/606; B01D 2257/504; B01D 2258/0233; B01D 2258/025; B01D 2259/124; B01D 2325/42

(57) ABSTRACT

A method of isolating carbon dioxide is disclosed. The method provides a vessel comprising a first chamber and a second chamber separated by a cation exchange membrane, providing in the first chamber a first solution comprising a metal carbonate, providing in the second chamber a second solution comprising an acid, acidifying the first solution by allowing protons from the second solution pass through the cation exchange membrane, forming a salt in the second solution by allowing metal ions from the first solution to pass through the cation exchange membrane, and isolating the carbon dioxide. Apparatus for isolating carbon dioxide is also disclosed.

### CROSS-REFERENCE TO RELATED APPLICATIONS

This application claims the benefit of U.S. Provisional Application No. 63/313,044, filed Feb. 23, 2022, U.S. Provisional Application No. 63/319,163, filed Mar. 11, 2022, and U.S. Provisional Application No. 63/326,584, filed Apr. 1, 2022, incorporated herein by reference in its entirety.

### TECHNICAL FIELD

The subject matter described herein relates to apparatus and methods of isolating carbon dioxide using a halogen.

### BACKGROUND

The combined production of cement and steel accounts for ˜15% of global anthropogenic CO₂ emissions. The cement industry releases more than 2 billion tons of carbon dioxide into the air each year to make its ubiquitous building material.

There is a need to find solutions for either decarbonizing the cement industry to achieve a net-zero emissions economy or to remove CO₂ directly from the air.

### BRIEF SUMMARY

In brief, the present disclosure provides methods, systems, and apparatus for isolating carbon dioxide from metal carbonates or air.

A reactor for isolating carbon dioxide is disclosed. The reactor comprises a vessel separated into a first chamber and a second chamber by an ion exchange membrane, wherein the vessel (100) is filled with water and the second chamber receives a halogenated gas. The reactor further comprises a first inlet fluidly connected to a body of the first chamber, wherein the first inlet receives a metal carbonate. The reactor further comprises a first outlet fluidly connected to a lower portion of the first chamber, wherein the first outlet is configured to collect a solid residue. The reactor further comprises a second outlet fluidly connected to a lower portion of the second chamber. The reactor further comprises a first gas outlet fluidly connected to an upper portion of the first chamber, wherein the first gas outlet releases carbon dioxide.

An apparatus for isolating carbon dioxide is disclosed. The apparatus comprises a first chamber comprising a metal carbonate and may further comprise a salt. The apparatus further comprises a second chamber comprising an acid, wherein the second chamber is separated from the first chamber by a cation exchange membrane.

A method of isolating carbon dioxide is disclosed. The method comprises a step of providing a vessel comprising a first chamber and a second chamber separated by a cation exchange membrane. The method further comprises a step of providing in the first chamber a first solution comprising a metal carbonate. The method further comprises a step of providing in the second chamber a second solution comprising an acid. The method further comprises acidifying the first solution by allowing protons from the second solution pass through the cation exchange membrane. The method further comprises forming a salt in the second solution by allowing metal ions from the first solution to pass through the cation exchange membrane. The method further comprises isolating the carbon dioxide.

A method of producing calcium hydroxide is disclosed. The method comprises a step of providing a first solution comprising calcium carbonate and sodium chloride. The method further comprises a step of providing a second solution comprising aqueous chlorine. The method further comprises a step of flowing the first solution into a first chamber of a vessel comprising a cation exchange membrane separating the first chamber from a second chamber. The method further comprises a step of flowing the second solution into the second chamber. The method further comprises a step of acidifying the first solution by allowing protons from the second solution pass through the cation exchange membrane thereby forming a third solution comprising calcium chloride. The method further comprises a step of contacting the third solution with a fourth solution comprising sodium hydroxide to form calcium hydroxide.

A method of isolating carbon dioxide is disclosed. The method comprises a step of providing a cabin comprising a first space and a second space separated by a reactor comprising a cation exchange membrane, wherein the first space comprises first carbon dioxide. The method further comprises a step of basifying the first carbon dioxide with a first solution comprising NaOH to form NaHCO3 and H2O in the reactor. The method further comprises a step of providing in the reactor a second solution comprising an acid. The method further comprises a step of acidifying the first solution by allowing protons from the second solution pass through the cation exchange membrane to release CO2 (g). The method further comprises a step of forming a salt in the second solution by allowing metal ions from the first solution to pass through the cation exchange membrane. The method further comprises a step of isolating and providing the carbon dioxide to the second space.

A method of isolating carbon dioxide is disclosed. The method comprises a step of providing a vessel comprising a first chamber and a second chamber separated by a cation exchange membrane. The method further comprises a step of providing in the first chamber a first solution comprising a metal carbonate. The method further comprises a step of providing in the second chamber a second solution comprising an acid. The method further comprises acidifying the first solution by allowing protons from the second solution pass through the cation exchange membrane. The method further comprises forming a salt in the second solution by allowing metal ions from the first solution to pass through the cation exchange membrane. The method further comprises isolating the carbon dioxide. The method further comprises reacting the salt formed in the second solution with a metal oxide catalyst to form oxygen and aqueous sodium chloride solution. The method further comprises electrolyzing the aqueous sodium chloride solution to form a halogen gas and the metal base.

Various aspects and embodiments now will be described more fully hereinafter. Such aspects and embodiments make take many different forms and the exemplary ones disclosed herein should not be construed as limiting: rather, these embodiments are provided so that this disclosure will be thorough and complete, and will fully convey its scope to those skilled in the art.

### BRIEF DESCRIPTION OF THE DRAWINGS

FIG. 1A illustrates a metal acidification reactor according to certain embodiments of the present disclosure.

FIG. 1B illustrates a diagram showing chemistry within the reactor according to certain embodiments of the present disclosure.

FIG. 1C illustrates a diagram showing chemistry within the reactor according to certain embodiments of the present disclosure.

FIG. 1D illustrates a diagram showing chemistry within the reactor according to certain embodiments of the present disclosure.

FIG. 1E illustrates a diagram showing chemistry for manufacturing of calcium hydroxide within the reactor according to certain embodiments of the present disclosure.

FIG. 1F illustrates a diagram showing chemistry within the reactor according to certain embodiments of the present disclosure

FIG. 2A illustrates a diagram showing the attachment of an enclosed space CO₂ cold capture device, an embodiment of the disclosure.

FIG. 2B illustrates a schematic showing the flow of compounds through the components of a closed-loop CO₂ cold-capture device, an embodiment of the disclosure.

FIG. 2C illustrates a schematic showing the flow of compounds through the components of a closed-loop CO₂ cold-capture device, an embodiment of the disclosure, for production of dry air.

FIG. 3 is a simplified flowchart illustrating carbon dioxide isolating method according to certain embodiments of the present disclosure.

FIG. 4 is a simplified flowchart illustrating calcium hydroxide production method according to certain embodiments of the present disclosure.

FIG. 5 is a simplified flowchart illustrating carbon dioxide isolating method in enclosed space according to certain embodiments of the present disclosure.

FIG. 6 is a simplified flowchart illustrating carbon dioxide isolating and aqueous sodium chloride electrolysis method according to certain embodiments of the present disclosure.

FIG. 7 illustrates a diagram showing chemistry within the reactor according to certain embodiments of the present disclosure.

FIG. 8 illustrates a diagram showing chemistry within the reactor according to certain embodiments of the present disclosure.

### DETAILED DESCRIPTION

### I. Definitions

For convenience, certain terms employed in the specification, examples and claims are collected here. Unless defined otherwise, all technical and scientific terms used in this disclosure have the same meanings as commonly understood by one of ordinary skill in the art to which this disclosure belongs.

The singular forms “a,” “an,” and “the” include plural referents unless the context clearly dictates otherwise. Thus, for example, reference to a “polymer” includes a single polymer as well as two or more of the same or different polymers, reference to an “excipient” includes a single excipient as well as two or more of the same or different excipients, and the like.

The terms “comprise(s),” “include(s),” “having,” “has,” “can,” “contain(s),” and variants thereof, as used herein, are intended to be open-ended transitional phrases, terms or words that do not preclude additional acts or structures. The present disclosure also contemplates other embodiments “consisting,” “consisting of” and “consisting essentially of,” the embodiments or elements presented herein, whether explicitly set forth or not.

The term “about”, particularly in reference to a given quantity, is meant to encompass deviations of plus or minus five percent.

As used herein, the term “calcination” refers to heating solids to a high temperature to remove volatile substances, oxidize a portion of the mass, or render them friable. In certain embodiments of the present disclosure, the term “calcination” refers to driving off CO₂ from a metal carbonate to produce the corresponding metal oxide. For instance, but not by way of limitation, calcination of calcium carbonate refers to the process of heating calcium carbonate to a high temperature to produce carbon dioxide and calcium oxide.

The term “clinker” or “lime clinker,” as used herein, refers to a product of calcium hydroxide with clay that has been processed inside a kiln.

The term “Portland cement,” as used herein, refers to a mixture of lime clinker with small amounts of gypsum that is ground into a powder, as is an industry-standard for cement. Portland cement goes on to get blended with water, sand, and gravel to form concrete, the rocky material used to make building foundations, roads, dams, and most modern infrastructure.

The term “alumina,” as used herein refers to aluminum oxide. Al₂O₃.

The term “flue gas,” as used herein refers to gas exiting to the atmosphere via a flue, which is a pipe or channel for conveying exhaust gases from a fireplace, oven, furnace, boiler, or steam generator.

The term “flue scrubber,” as used herein refers to the removal of pollutants from industrial exhaust systems.

The term “air contactor,” as used herein refers to a small device that controls the flow of electricity to one of the air conditioner's components.

The term “chlorine water,” as used herein refers to water mixed with a chlorine gas generating HCl and HOCl as shown in the equation (1).

### Cold Capture of Carbon Dioxide

In certain embodiments, the present disclosure provides a method and an apparatus for cold capture of carbon dioxide. The cold capture of carbon dioxide does not require a source of heat to isolate the carbon dioxide. In certain embodiments, carbon dioxide is captured from air.

In certain embodiments, the carbon dioxide is captured from flue gas.

In certain embodiments, the process for cold capture of carbon dioxide is a two-step process. In certain embodiments, the first step includes a flue scrubber/air contactor with a base. In this regard, air or exhaust is collected at the flue serubber or air contactor containing carbon dioxide, which is treated with a base. In certain embodiments, the base is a water-soluble Group IA or Group IIA base. In certain particular embodiments, the base is NaOH.

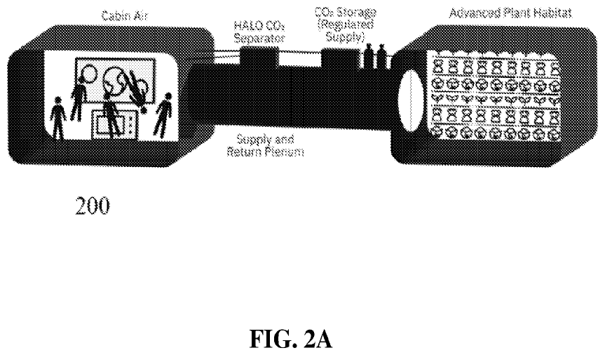

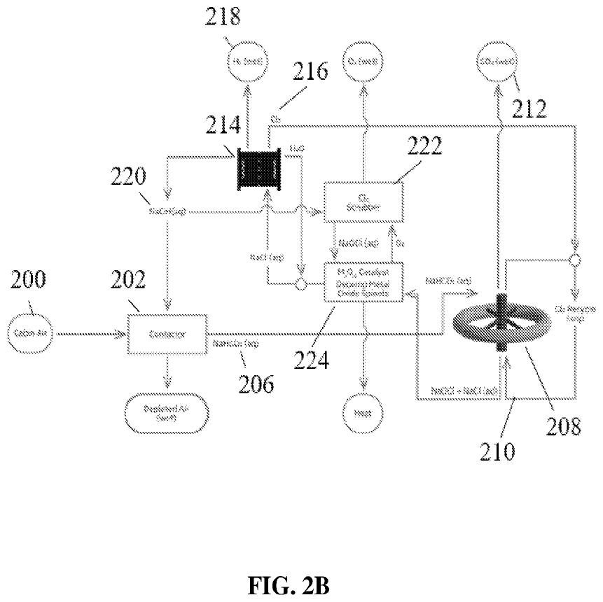

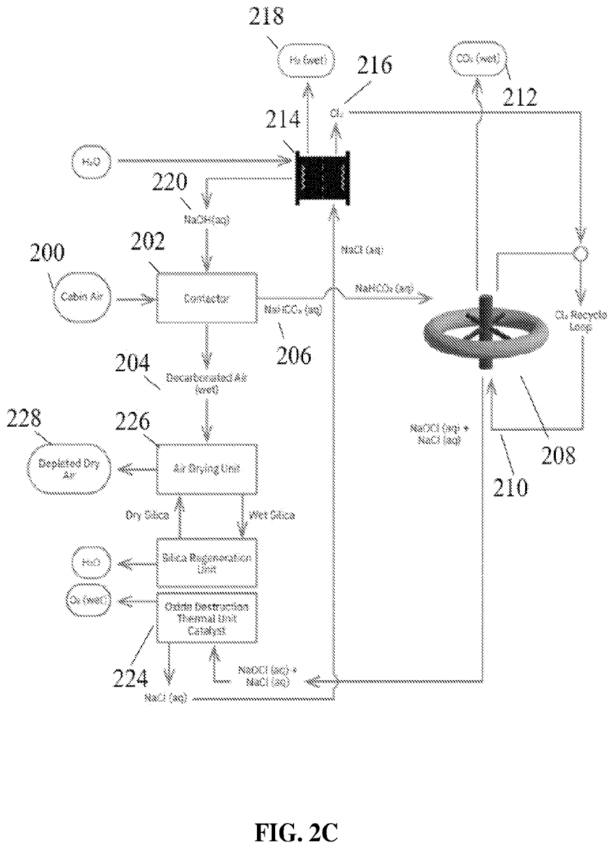

In certain embodiments, carbon dioxide from air and/or flue gas reacts with the base to form a metal carbonate. In certain particular embodiments, the metal carbonate is NaHCO₃. Na₂CO₃, or a mixture thereof. The resulting solution of metal carbonate can be stored or processed as further described in the following section. This process is exemplified in FIGS. 2B-2C.

Isolation of Carbon Dioxide from Metal Carbonates

In certain embodiments, the present disclosure provides a method and an apparatus for isolating carbon dioxide.

In certain embodiments, carbon dioxide is isolated from a metal carbonate using an acid. In certain embodiments, the metal carbonate is Li₂CO₃, Na₂CO₃, K₂CO₃, MgCO₃, CaCO₃, SrCO₃, FeCO₃, and BaCO₃. In certain embodiments, the metal of the metal carbonate is such that the metal halide is soluble and more stable in acid than the metal carbonate. In certain particular embodiments, the metal carbonate is CaCO₃.

In certain embodiments, the metal carbonate is a group IA or a group IIA metal carbonate. In certain embodiments, the metal carbonate is obtained from a reaction between a metal hydroxide and carbon dioxide as described above. In certain embodiments, the metal carbonate is Na₂CO₃, and it is obtained from a reaction between NaOH and carbon dioxide.

In certain embodiments, carbon dioxide is released from the carbonate by reaction with an acid. In certain embodiments, the acid suitable for release of carbon dioxide is a stronger acid than carbonic acid. For example, the acid which has pKa less than 6.35 in water at 25° C, is used. This avoids fouling the membrane. At a low pH such as pKa of less than 6.35, the metal species are unlikely to precipitate, and thus there was no risk of fouling if there was a substantial pH gradient across the membrane. In certain embodiments, the acid is derived from a halogen. In certain embodiments, the halogen is chlorine or bromine.

In certain particular embodiments, the acid is derived from Cl₂. In certain particular embodiments, the acid is derived from a reaction of Cl₂ with water.

In certain embodiments. Cl₂ used in the process of the present disclosure is obtained from saltwater electrolysis. When there is a low demand for acid or base or a dislocation between the demand for hydrogen and other products of saltwater electrolysis, the chlorine can be surplus, thereby making it an economical starting material.

In certain embodiments, the process for carbon dioxide isolation begins by saturating water with halogen. For clarity and illustration purposes, the embodiments of the present disclosure will be described herein using Cl₂ as a halogen; however, as would be readily understood by a person of ordinary skill in the art, other halogens, including bromine, can also be used in the systems disclosed herein and the reactions would proceed by analogous mechanisms. For instance, but not by way of limitation, when the halogen is chlorine, the method includes forming chlorine water. If a halogen of choice is fluorine, bromine, or iodine, fluorine water, bromine water, or iodine water would form. The halogen water may be a saturated halogen water.

Chlorine water has a pH of ˜1.6. Bromine water has a pH range of 2-3. Cl₂ can then oxidize water as shown by equation (1):

Cl₂+H₂O→HCl+HOCl (1)

The Kₐ of HCl is 10⁶. Although the Kₐ of HOCl is small (10⁻⁸), the disproportionation product HClO₃ has a large pKa above 10⁹. Protons of the halogen water can further react with metal carbonate. In certain embodiments, when the metal carbonate is calcium carbonate, CaCO₃, calcium bicarbonate, Ca(HCO₃)₂(aq) can be formed first, which is then turned into Ca²⁺(aq) and carbonic acid, H₂CO₃. Carbonic acid then readily decomposes into water and carbon dioxide. This reaction is summarized in the equation (2) below.

CaCO₃+2H⁺→Ca²⁺(aq)+H₂O+CO₂(g) (2)

In certain embodiments, when the metal carbonate is sodium carbonate and/or sodium bicarbonate, it can be turned into Na⁺(aq) and carbonic acid, H₂CO₃. Carbonic acid then readily decomposes into water and carbon dioxide. This reaction is similar to the equation (2) with calcium carbonate.

Na₂CO₃+2H⁺→2Na⁺(aq)+H₂O+CO₂(g) (3)

NaHCO₃+H⁺→Na⁺(aq)+H₂O+CO₂(g) (4)

The carbon dioxide leaves the solution as a gas and can be collected.

In certain embodiments, the halogen water is kept separate from the metal carbonate solution using a cation exchange membrane. Thus, the protons may traverse the membrane and react with the metal carbonate, but the halogens are prevented from interacting with the carbon species because the halogens do not pass through the cation exchange membrane

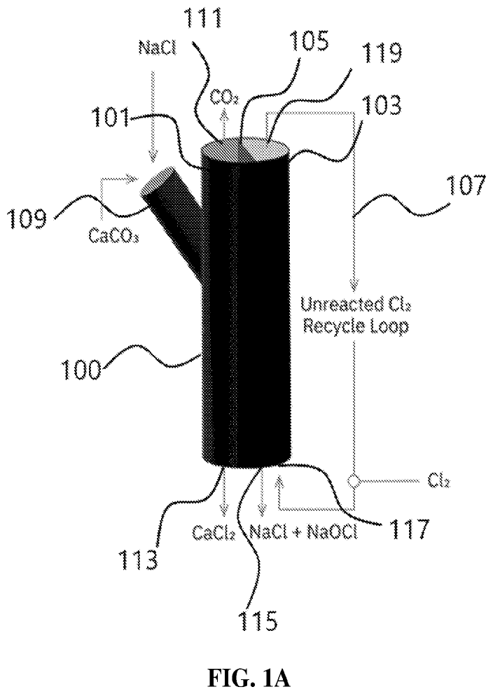

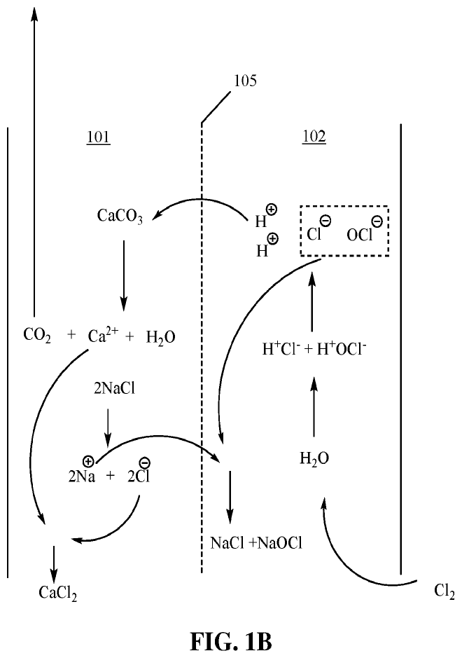

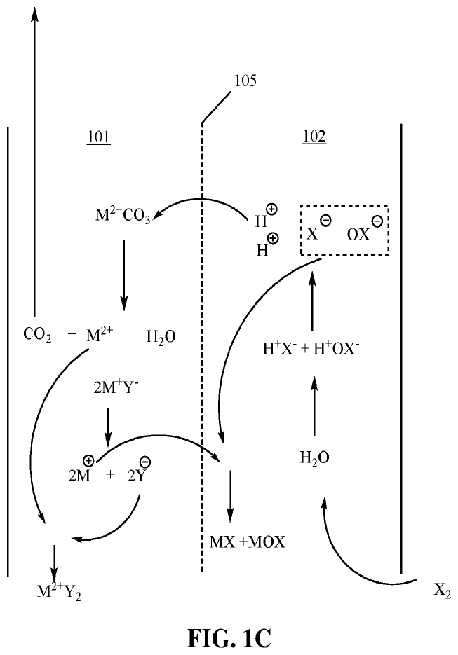

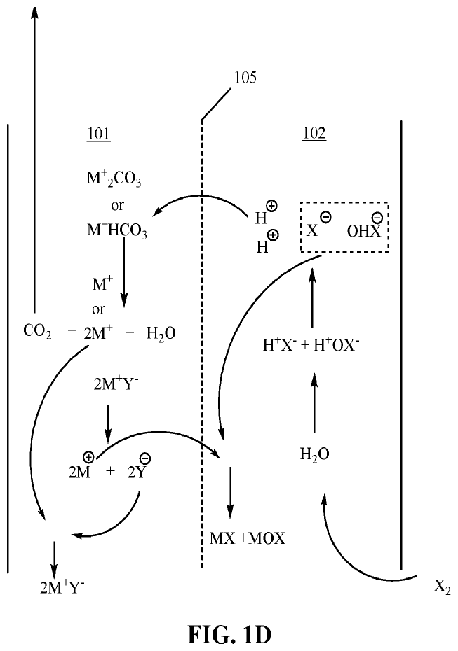

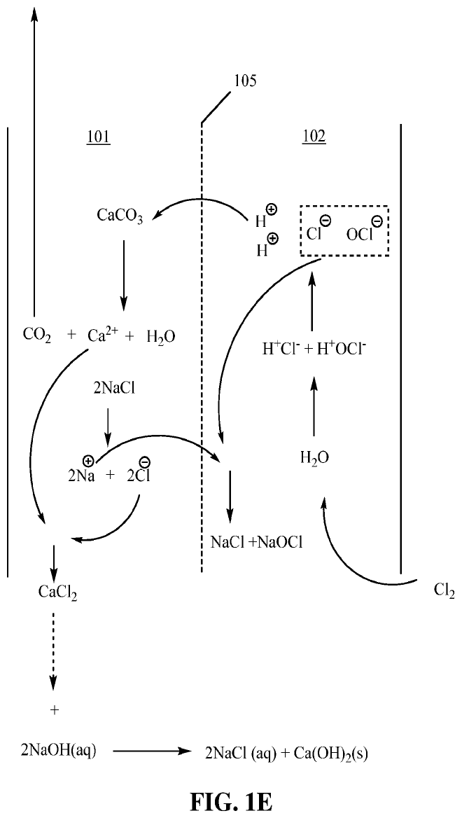

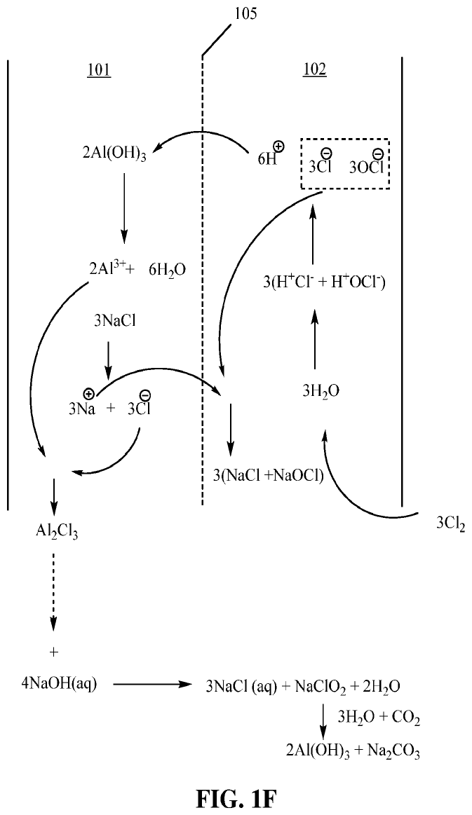

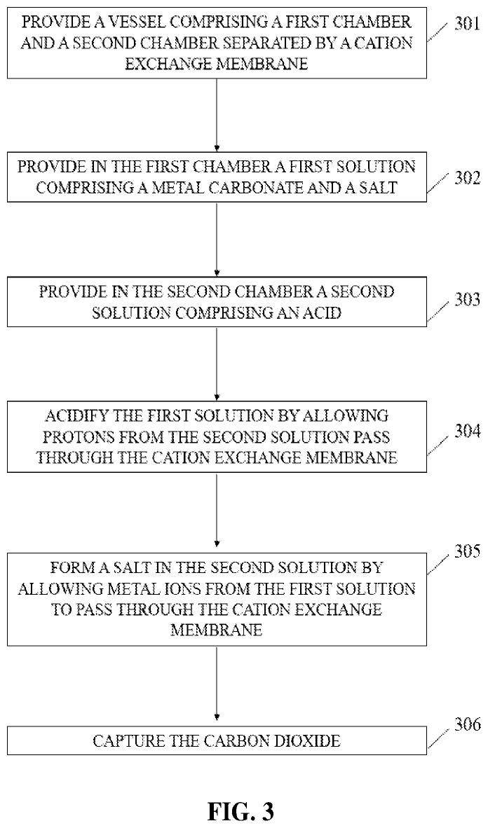

In certain embodiments, the acidification of the metal carbonate such as CaCO₃ can be done using a reactor as displayed in FIG. 1A. While FIG. 1A illustrates and embodiment where CaCO₃ is the metal carbonate, and Cl₂ is the halogen and NaCl is the salt, a person of ordinary skill in the art would readily recognize that the system would work analogously for other metal carbonates such as Na₂CO₃ or NaHCO₃, halides and salts discussed in this application. As shown in FIG. 1A, in this embodiment the reactor includes a vertical tube 100, which is vertically divided into a first compartment 101 and a second compartment 103 by a cation exchange membrane 105. The tube is filled with water. As shown in FIG. 3, the apparatus includes a gas outlet 111 fluidly connected to the first chamber 101, a first liquid inlet 109 fluidly connected to the first chamber 101, a first liquid outlet 113 fluidly connected to the first chamber 101, and a second liquid outlet 115 fluidly connected to the second chamber 103.

In certain embodiments, instead of using vertical tube 100, the tube may be in another orientation. In certain other embodiments, instead of using vertical tube 100, the reactor may use a flow field, such as a serpentine flow field, divided by cation exchange membrane 105.

In the first step, a solution of metal carbonate such as calcium carbonate and sodium chloride is added to the first compartment 101. In certain embodiments, halide gas, such as chlorine, is added to the second compartment 103 through a gas inlet 117 at the bottom of the second compartment 103, forming saturated chlorine water. In certain other embodiments, saturated chlorine water can be prepared separately and directly added into the second chamber 103. As shown in FIG. 1A, the unreacted chlorine can be collected from the top of the second compartment through a gas outlet 119. The gas inlet 117 and outlet 119 are fluidly connected to enable recycling of unreacted halide gas.

Protons from the chlorine water can cross the cation exchange membrane 105, thereby acidifying the metal carbonate to provide carbonic acid, which, as discussed above, readily decomposes into water and carbon dioxide. Carbon dioxide can then be removed from the reaction as a gas through the gas outlet 111.

In some embodiments, salt may be added. The sodium from the added salt charge balances the protons by crossing the membrane into the second chamber, forming sodium chloride (NaCl) and sodium hypochlorite (NaOCl). The sodium hypochlorite may be decomposed thermally or catalytically to yield either NaClO₃ or NaCl and O₂. In certain embodiments, sodium hypochlorite can be used or decomposed by certain transition metal oxide catalysts such as molybdenum promoted manganese oxide catalyst, used for bleaching, or isolated as NaClO₃ for rocket fuel oxidizer.

Chloride left behind in the first compartment charge balances the metal ion, c.g., Ca²⁺. In some embodiments where the metal carbonate is calcium carbonate, and the halide is chlorine, the overall transformation is shown by equation (5):

CaCO₃+Cl₂+2NaCl+H₂O→CaCl₂+CO₂(g)+NaOCl+NaCl+H₂O (5)

The salt (NaCl) and leftover halogen gas (Cl₂) can be recycled. While the salt may be used for charge balance, it may be omitted.

In certain embodiments, the cation exchange membrane can be Nafion, or any oxidation-resistant cation exchange membrane. In certain embodiments a physical barrier such as glass fiber may also be employed.

Cation exchange membranes can suffer from failures in the presence of divalent hard cations, such as Mg²⁺ and Ca²⁺, which can react with carbon dioxide to form accretions in the membranes, called “membrane fouling” due to solubility properties of magnesium and calcium carbonates. However, by maintaining a system pH of ˜2 at the cation exchange membrane, CO₃²⁻ mineralization damage from CO₂ evolution in the membranes is prevented.

In one embodiment, the reactor comprises a vessel 100 separated into a first chamber 101 and a second chamber 103 by an ion exchange membrane 105, wherein the vessel 100 is filled with water H₂O and the second chamber receives a halogenated gas. In one embodiment, the reactor further comprises a first inlet 109 fluidly connected to a body of the first chamber, wherein the first inlet receives a metal carbonate. In one embodiment, the reactor further comprises a first outlet 113 fluidly connected to a lower portion of the first chamber, wherein the first outlet is configured to collect a solid residue. In one embodiment, the reactor further comprises a second outlet 115 fluidly connected to a lower portion of the second chamber. In one embodiment, the reactor further comprises a first gas outlet 111 fluidly connected to an upper portion of the first chamber, wherein the first gas outlet releases carbon dioxide.

In some embodiments, the reactor further comprises a second gas inlet 117 fluidly connected to the lower of the second chamber than the second outlet, wherein the second gas inlet receives the halogenated gas. In some embodiments, the reactor further comprises a second gas outlet 119 fluidly connected to the upper portion of the second chamber and configured to collect unreacted balogenated gas from the second gas inlet. In some embodiments, the ion exchange membrane is a cation exchange membrane. In some embodiments, the reactor vertically separates the vessel into the first chamber and the second chamber. In some embodiments, the first outlet is fluidly connected to a bottom surface of the first chamber. In some embodiments, the lower portion of the first chamber is the bottom surface of the first chamber. In some embodiments, the second outlet is fluidly connected to a bottom surface of the second chamber. In some embodiments, the lower portion of the second chamber is the bottom surface of the second chamber. In some embodiments, the first gas outlet is fluidly connected to a top surface of the first chamber. In some embodiments, the upper portion of the first chamber is the top surface of the first chamber.

In some embodiments, the reactor further comprises a second inlet fluidly connected to the upper portion of the second chamber. In some embodiments, the first inlet further receives an alkaline metal salt. In some embodiments, the alkaline metal salt is NaCl. In some embodiments, the metal carbonate is Li₂CO₃, Na₂CO₃, NaHCO₃, K₂CO₃, MgCO₃, CaCO₃, SrCO₃, FeCO₃, BaCO₃, or combination thereof. In some embodiments, the metal carbonate is CaCO₃, NaHCO₃, Na₂CO₃, or combination thereof In some embodiments, the metal carbonate is CaCO₃. In some embodiments, the metal carbonate is NaHCO₃. In some embodiments, the metal carbonate is Na₂CO₃.

In some embodiments, the halogenated gas is F₂, Cl₂, Br₂, I₂, or combination thereof. In some embodiments, the halogenated gas is Cl₂. In some embodiments, the halogenated gas is Br₂.

In some embodiments, the halogenated gas is I₂. In some embodiments, the halogenated gas is F₂.

In some embodiments, the halogenated gas from the second gas inlet reacts with water to form HCl and HOCl. The reaction of Cl₂ and H₂O to form HCl and HOCl is shown in the equation (1) below.

Cl₂+H₂O→HCl+HOCl (1)

In some embodiments, a proton H⁺ in the second chamber dissociated from HCl and HOCl moves across the ion exchange membrane to the first chamber. In some embodiments, the proton H⁺ moved from the second chamber reacts with the metal carbonate to form the carbon dioxide. The reaction of the metal carbonate, for example CaCO₃, with the proton to form CO₂ is shown in the equation (2) below.

CaCO₃+2H⁺→Ca²⁺(aq)+H₂O+CO₂(g) (2)

In some embodiments, the alkaline metal salt NaCl is added to the first chamber. NaCl salt dissociates into Na⁺ and Cl⁻ in water. In some embodiments, an alkaline metal cation, for example Na⁺, in the first chamber pass through the ion exchange membrane to the second chamber. In some embodiments, the alkaline metal cation moved from the first chamber reacts with a halide anion Cl⁻ and hypochlorite OCl⁻ anion to form a metal halide and a metal hypohalide. In this regard. the alkaline metal cation Na⁺ reacts with a halide anion Cl⁻ and hypochlorite OCl⁻ anion formed from the reaction of Cl₂ and H₂O in the equation (1) to form NaCl and NaOCl. This reaction is shown below in the equation (17).

2 Na⁺+Cl⁻+OCl⁻→NaCl+NaOCl (17)

In some embodiments, when NaCl salt dissociates Na⁺ and Cl⁻ in water and the cation Nat is used in the second chamber by passing through the ion exchange membrane, the remaining anion Cl⁻ in the first chamber further reacts with Ca²⁺ formed from the equation (2). This results in formation of CaCk, as shown in the equation (18) below.

2 Cl⁻+Ca²⁺→CaCl₂ (18)

In some embodiments, the CaCl₂ is collected at the first outlet. In some embodiments, the CaCl₂ is collected as a solid residue. It's noted that while an alkaline metal salt such as NaCl is optionally added through the first inlet 109 as shown in FIG. 1A, a generation of CO₂ does not require an alkaline metal salt. FIG. 1B is a schematic representation of chemistry that takes place within the first chamber 101 and the second chamber 102 separated by an ion exchange membrane 105. FIG. 1C is a generic schematic representation of chemistry that takes place within the first chamber 101 and the second chamber 102 separated by an ion exchange membrane 105. A halogenated gas is shown as X₂. Alkaline earth metal carbonate is shown as M²⁺CO₃. Alkali metal halide is shown as M¹⁺Y. As discussed throughout the disclosure, in some embodiments, X is F, Cl, Br, I, or combination thereof. In some embodiments, M²⁺ is Be²⁺, Mg²⁺, Ca²⁺, Sr²⁺, Ba²⁺, Ra²⁺, or combination thereof. In some embodiments, M¹⁺ is Lit, Na⁺, K⁺, Rb⁺, Cs⁺, Fr⁺, or combination thereof. In some embodiments. Y is F, Cl, Br, I, or combination thereof. In some embodiments, an alkali metal carbonate is used in the first chamber 101. FIG. 1D is a generic schematic representation of chemistry that takes place within the first chamber 101 and the second chamber 102 separated by an ion exchange membrane 105.

In one embodiment, the apparatus comprises a first chamber comprising a metal carbonate and a salt. The apparatus further comprises a second chamber comprising an acid, wherein the second chamber is separated from the first chamber by a cation exchange membrane. In some embodiments, the metal carbonate is selected from the group consisting of Li₂CO₃, NaHCO₃, NaCO₃, K₂CO₃, MgCO₃, CaCO₃, SrCO₃, BaCO₃, and combinations thereof. In some embodiments, the salt is NaCl. In some embodiments, the acid has pKₐ of less than 6.35. In some embodiments, the acid comprises water saturated with a halogen gas. In some embodiments, the halogen gas is Cl₂. In some embodiments, the metal carbonate is NaHCO₃. In some embodiments, the metal carbonate is CaCO₃.

### Processing of Metal Halides

In certain embodiments, after removing carbon dioxide, the reaction mixture has an aqueous metal salt. In certain embodiments, a base can be added to the aqueous metal salt to produce a different compound of interest. In certain embodiments, the resulting compound has low solubility in water and can be therefore easily removed from the reaction mixture by filtration.

The resulting compound can be a metal base with low water solubility in certain embodiments. In certain embodiments, the resulting compound is Mg(OH)₂, Ca(OH)₂ or Sr(OH)₂. In such embodiments, the aqueous metal salt can be mixed with a water-soluble base. For example, the water-soluble base includes a water-soluble metal IA or metal IIA base.

In certain embodiments, the apparatus shown in FIG. 1A can be modified by adding a third compartment fluidly connected to the first liquid outlet 113. In certain embodiments, the aqueous metal salt produced in the first compartment 101 can be moved into a third compartment that includes a water-soluble base such as a water-soluble metal IA or metal IIA base.

In certain particular embodiments, if the starting materials are calcium carbonate, sodium chloride, and chlorine gas, as shown by equation (3), the reaction produces calcium chloride, CaCl₂. In certain embodiments, the calcium chloride solution can be mixed with a sodium hydroxide solution. This can be done with a low-grade, straight-run, unrefined chloralkali catholyte with high salt content. This reaction may result is the rapid precipitation of calcium hydroxide (Ca(OH)₂), which is three orders of magnitude less soluble than calcium chloride, sodium chloride, and sodium hydroxide, as shown by equation (6):

CaCl₂(aq)+2NaOH(aq)→2NaCl(aq)+Ca(OH)₂(s) (6)

In certain embodiments, the sodium hydroxide solution can be placed in a third chamber fluidly connected to a first liquid outlet 113 of the first chamber 101.

In certain embodiments, the Ca(OH)₂ may be kept at low temperatures or high dilutions to prevent its precipitation in the cell. The Ca(OH)₂(l) may flow out of the cell into a separate chamber before it is precipitated.

Calcium hydroxide provided from the reaction between CaCl₂ and NaOH can subsequently be removed by a filtration. The calcium hydroxide may be used for making Portland Cement. In certain embodiments, the resulting calcium hydroxide can be mixed with salts, clays. sand, and/or gravel to make cement. In certain embodiments, the resulting cement can absorb carbon dioxide from the atmosphere, making the process carbon negative. The sodium chloride that is produced in this reaction can then be recycled and used in carbon dioxide isolation reaction. FIG. 1E illustrates the manufacturing of calcium hydroxide shown in the equation (6).

In other embodiments, a saturated solution with a halogen can be separately prepared and provided to the second chamber 103 through an inlet fluidly connected to the second chamber 103.

### Production of Metal Halides

In certain embodiments, the methods and apparatus of the present disclosure can also be used to prepare metal halides. In certain embodiments, the methods and apparatus of the present disclosure can be used to prepare aluminum halides, and in particular, AlCl₃. The metal halide, and in particular AlCl, can then be used to create the corresponding metal oxide, in particular alumina (Al₂O₃). In certain embodiments, bauxite is used as a starting material for alumina. Bauxite includes a mixture of hydrous aluminum oxides and aluminum hydroxides. However, a person of ordinary skill in the art would recognize that other insoluble metal oxides, hydroxides, sulfates, and carbonates, or mixtures thereof, can be used. A reactor, as shown in FIG. 1A, which includes a vertical tube, has a feeder branch and is vertically divided into two compartments by a cation exchange membrane can be used in alumina production. In certain embodiments, instead of using a vertical tube, the tube may be in another orientation. In certain other embodiments, instead of using a vertical tube, the reactor may use a flow field, such as a serpentine flow field.

A suspension of a metal oxide, hydroxide, sulfate, or carbonate and NaCl in water may be reacted with halide water, such as chlorine water, across a cation exchange membrane. In particular, bauxite and NaCl in water may be reacted with halide water, such as chlorine water, across a cation exchange membrane. Protons from the halide water can cross the cation exchange membrane, thereby acidifying the metal oxide, hydroxide, sulfate, or carbonate to yield a metal halide, which is water-soluble. The flow of protons across the membrane can be balanced by flow of Na⁺. In particular, bauxite may be reacted with chlorine water, thereby acidifying the hydrous aluminum oxides and aluminum hydroxides of the suspension to yield aluminum chloride (AlCl₃), which is water-soluble. Subsequently, the metal chloride solution can be mixed with a water-soluble base, e.g., a water-soluble metal IA or metal IIA base, thereby making a metal hydroxide, which can be separated by filtration. In certain particular embodiments, the water-soluble base is sodium hydroxide. In certain particular embodiments, the metal chloride is aluminum chloride.

In certain embodiments, sodium hydroxide can be added to the solution of aluminum chloride to produce a mixture of sodium chloride and soluble sodium aluminate, NaAlO₂:

AAlCl₃+4NaOH→3NaCl+NaAlO₂+2H₂O (7)

The solution can be filtered to remove insoluble hydroxides of other metals. In certain embodiments, the sodium aluminate can be converted to aluminum hydroxide by bubbling carbon dioxide through it:

NNaAlO₂+3H₂O+CO₂→2Al(OH)₃+Na₂CO₃ (8)

Alternatively, the sodium aluminate solution can be concentrated, and aluminum hydroxide can be precipitated from a supersaturated solution with a high-purity aluminum hydroxide crystal.

In certain embodiments, the isolated aluminum hydroxide can be converted to alumina by heating in rotary kilns or fluid flash calciners to a temperature of about 1470 K:

2Al(OH)₃→Al₂O₃+3H₂O (9)

Referring to FIGS. 2A-2C, one embodiment of the current disclosure solves the problem of CO₂ concentration fluctuation in plant habitats. One embodiment of the present disclosure uses chlorine in a chlorine destruction reaction to isolate CO₂ from a gas. The manufacturing of metal halide, specifically aluminum halides, is illustrated in FIG. 1F.

Isolation of Carbon Dioxide from Air using a Closed Loop

One embodiment of the present disclosure brings the sodium hydroxide into contact with cabin air 200 driven through a honeycomb contactor 202 until the exit solution is buffered to pH ˜8 to yield sodium bicarbonate 206 and wet decarbonized air 204 and the reaction is shown in equation (10). While this example suggests the use of a honeycomb contactor, any appropriate wet scrubber may be used.

NaOH(aq)+CO₂(N₂+O₂)→NaHCO₃(aq)+H₂O(N₂+O₂) (10)

An advantage and dissimilarity with standard chlor-alkali is evident in this step of one embodiment of the disclosure. Not only does the sodium hydroxide not need to be concentrated, since the pH of an 8% solution (2M) is already 14, but it may remain at or below 8% because near 8% the formed NaHCO₃ exceeds its solubility (˜100 g/L).

The decarbonated air 204 may be wet, having picked up humidity from the contactor 202. This can be dealt with outside the reactor or inside the reactor, depending on the ancillary resources available. The bicarbonate solution 206 is then taken to the neutralizer. The neutralizer 208 may have two chambers separated by a cation selective membrane which may divide it along the mirror plane. Chlorine 210 is brought to the other chamber, producing salt-free chlorine saturated water. Chlorine water has a pH ˜1.6 due to reaction (1), and acidic protons cross the membrane to enter the bicarbonate chamber, giving CO₂(g) 212 by the pH dependent decomposition of carbonic acid (11):

H₂CO₃→H₂O+CO₂ (11)

The protons are charge balanced by the diffusion of Na+ into the chlorine chamber, giving NaCl for the overall reaction (12):

Cl₂+H₂O∥2NaHCO₃→NaCl+NaOCl∥H₂O+CO₂ (12)

The membrane is vital to prevent the mixing of chlorine and CO₂, which may produce phosgene, chlorine dioxide, carbon tetrachloride, and other trace toxins (13):

Cl₂+CO₂→CₓCl_{y}O_{z} (13)

Destruction of the chlorine is completed through a recirculation loop and chlorine scrubber 222. The sodium hypochlorite may be catalytically decomposed to sodium chloride and oxygen over d-block metal oxide spinels 224, especially of copper, nickel, and cobalt (14):

2NaOCl→2NaCl+O₂ (14)

This gives the overall chlorine reaction (15):

2Cl₂+2H₂O→4HCl+O₂: ΔH=−114 KJ/mol (15)

Since both sides are four electron processes, this is coulombically equivalent to freshwater electrolysis, but retains the value in the acid. The heat of reaction is available for work since it is released upon catalysis and can be used to regenerate silica desiccant within the system for the production of dry gasses 228 (FIG. 2C) via an airdrying unit 226, or outside the system as desired. The produced oxygen may pass through a final scrub (16):

O₂+Cl₂+2NaOH→O₂+NaOCl+H₂O (16)

After the final scrub, the sodium hypochlorite may be decomposed to sodium chloride and oxygen as described in reaction (14). The sodium chloride solution 214 may then be electrolyzed to yield chlorine 216 and hydrogen gas 218. The chlorine gas 216 and sodium hydroxide 220 produced from saltwater electrolysis 214 may then be used as inputs to reactions (10) and (12), thus providing a method of indefinitely purifying CO₂ from cabin air.

An embodiment of the present disclosure may perform cach reaction simultaneously in a fluidized reactor that is easily automated and can operate at just 46% more power consumption than the singular step of water electrolysis, however, most of this energy is available to do work through the decomposition of the hypochlorite. Considering all-in efficiency, an embodiment of the present disclosure should be approximately twice as efficient as the existing state of the art. A Bosch Reactor can also be included to return water and humic carbon for soil using the excess products of an embodiment of the present disclosure.

The cold, pure CO₂ stream from an embodiment of the present disclosure is a significant advance over plug-flow or thermal swing DAC

In some embodiments, the cabin is an enclosed space. For example, the enclosed space is a room, aircraft cabin, or a spaceship cabin. In some embodiments, the reactor is attached in between the first space and the second space as exemplified in FIG. 2A.

Now referring to FIG. 3, in one, a method of isolating carbon dioxide is disclosed. The method comprises a step of providing a vessel comprising a first chamber and a second chamber separated by a cation exchange membrane (301). The method further comprises a step of providing in the first chamber a first solution comprising a metal carbonate (302). The method further comprises a step of providing in the second chamber a second solution comprising an acid (303). The method further comprises acidifying the first solution by allowing protons from the second solution pass through the cation exchange membrane (304). The method further comprises forming a salt in the second solution by allowing metal ions from the first solution to pass through the cation exchange membrane (305). The method further comprises isolating the carbon dioxide (306).

In some embodiments, the first solution further comprises a salt. In some embodiments, the metal carbonate is prepared by contacting a carbon dioxide containing gas to a metal base. In some embodiments, the metal carbonate is selected from the group consisting of Li₂CO₃, NaHCO₃, Na₂CO₃, K₂CO₃, MgCO₃, CaCO₃, SrCO₃, BaCO₃, and combinations thereof. In some embodiments, the metal carbonate is NaHCO₃. In some embodiments, the metal carbonate is CaCO₃. In some embodiments, the metal base is NaOH. In some embodiments, the salt is sodium chloride. In some embodiments, the acid has pKa of less than 6.35. In some embodiments, the acid has pKa of less than 6.0. In some embodiments, the acid has pKa of less than 5.0 In some embodiments, the acid has pKa of less than 3.0. In some embodiments, the acid comprises water saturated with a halogen. In some embodiments, the halogen is selected from the group consisting of fluoride, chlorine, bromine, iodine, and combinations thereof. In some embodiments, the halogen is chlorine or bromine. In some embodiments, the cation exchange membrane is Nation. In some embodiments, the method further comprises a step of adding a water-soluble metal IA or metal IIA base to a metal halide produced in the first chamber to produce a metal hydroxide selected from the group consisting of magnesium hydroxide, calcium hydroxide and strontium hydroxide. In some embodiments, the metal hydroxide is calcium hydroxide. In some embodiments, the method further comprises a step of isolating calcium hydroxide by filtration and using it to make clinker or Portland cement.

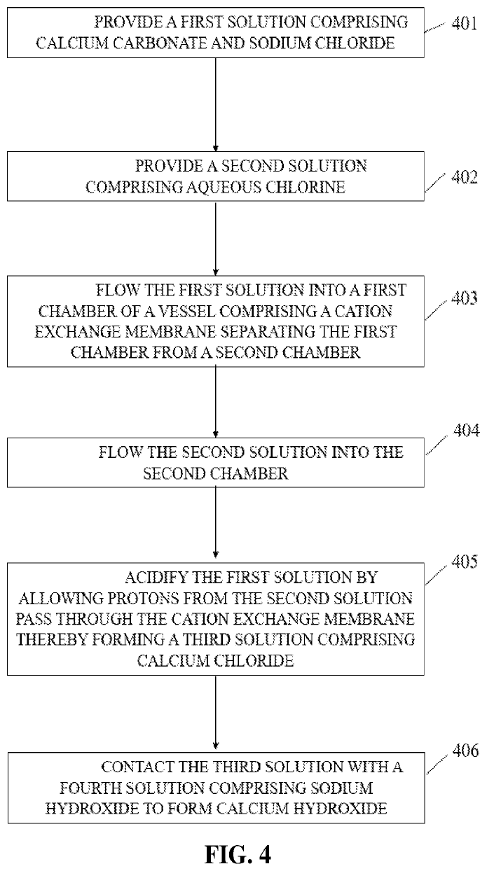

Now referring to FIG. 4, in one embodiment, a method of producing calcium hydroxide is disclosed. The method comprises a step of providing a first solution comprising calcium carbonate and sodium chloride (401). The method further comprises a step of providing a second solution comprising aqueous chlorine (402). The method further comprises a step of flowing the first solution into a first chamber of a vessel comprising a cation exchange membrane separating the first chamber from a second chamber (403). The method further comprises a step of flowing the second solution into the second chamber (404). The method further comprises a step of acidifying the first solution by allowing protons from the second solution pass through the cation exchange membrane thereby forming a third solution comprising calcium chloride (405). The method further comprises a step of contacting the third solution with a fourth solution comprising sodium hydroxide to form calcium hydroxide (406).

In some embodiments, the third solution is flown into a third chamber fluidly connected to the first chamber, wherein the third chamber comprises the fourth solution. In some embodiments, the aqueous chlorine is prepared by flowing a chlorine gas through a second gas inlet fluidly connected to the second chamber, wherein any unreacted chlorine gas is collected through a second has outlet fluidly connected to the second chamber, wherein the second gas inlet and the second gas outlet are connected via loop thereby enabling recycling of the unreacted chlorine gas. In some embodiments, the method further comprises a step of producing clinker by mixing clay with calcium hydroxide. In some embodiments, the ion exchange membrane is an anion exchange membrane instead of a cation exchange membrane.

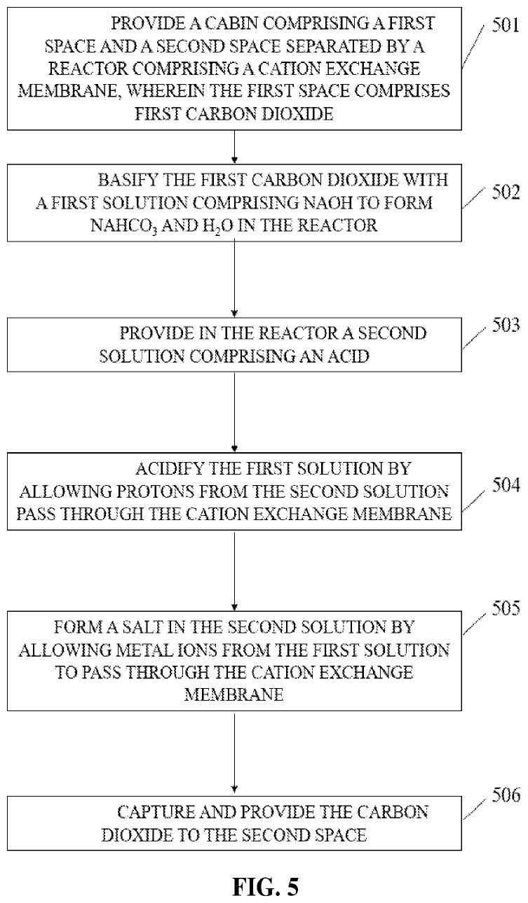

Now referring to FIG. 5, in one embodiment, a method of isolating carbon dioxide in the air is disclosed. The method comprises a step of providing a cabin comprising a first space and a second space separated by a reactor comprising a cation exchange membrane, wherein the first space comprises first carbon dioxide (501). The method further comprises a step of basifying the first carbon dioxide with a first solution comprising NaOH to form NaHCO₃ and H₂O in the reactor (502). The method further comprises a step of providing in the reactor a second solution comprising an acid (503). The method further comprises a step of acidifying the first solution by allowing protons from the second solution pass through the cation exchange membrane to release CO₂ (g) (504) The method further comprises a step of forming a salt in the second solution by allowing metal ions from the first solution to pass through the cation exchange membrane (505). The method further comprises a step of isolating and providing the carbon dioxide to the second space (506). The method may further comprise electrolyzing the saltwater.

In some embodiments, the acid has pKa of less than 6.35. In some embodiments, the acid has pKa of less than 6.0. In some embodiments, the acid has pKa of less than 5.0. In some embodiments, the acid has pKa of less than 3.0. In some embodiments, the acid comprises water saturated with a halogen. In some embodiments, the halogen is selected from the group consisting of fluoride, chlorine, bromine, iodine, and combinations thereof. In some embodiments, the halogen is chlorine or bromine. In some embodiments, the cation exchange membrane is Nafion.

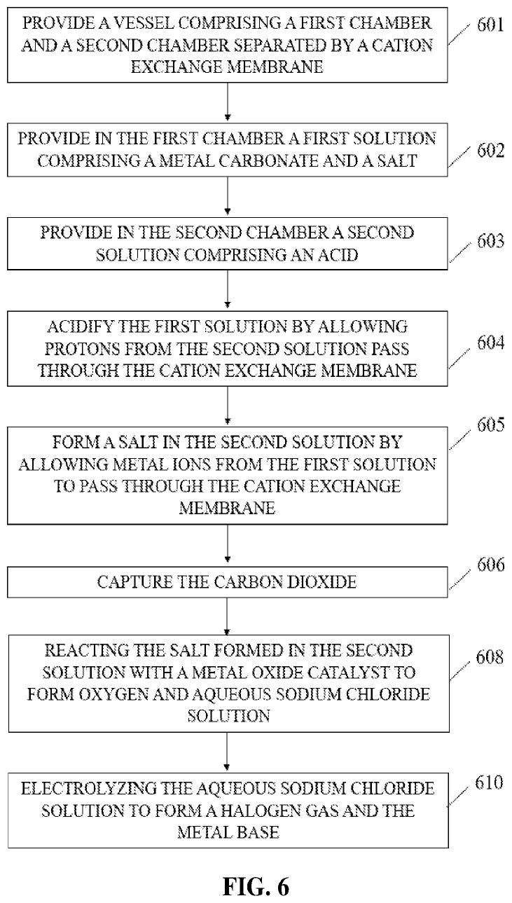

Now referring to FIG. 6, in one, a method of isolating carbon dioxide is disclosed. The method comprises a step of providing a vessel comprising a first chamber and a second chamber separated by a cation exchange membrane (601). The method further comprises a step of providing in the first chamber a first solution comprising a metal carbonate (602). The method further comprises a step of providing in the second chamber a second solution comprising an acid (603). The method further comprises acidifying the first solution by allowing protons from the second solution pass through the cation exchange membrane (604). The method further comprises forming a salt in the second solution by allowing metal ions from the first solution to pass through the cation exchange membrane (605). The method further comprises isolating the carbon dioxide (606). The method further comprises reacting the salt formed in the second solution with a metal oxide catalyst to form oxygen and aqueous sodium chloride solution (608). The method further comprises electrolyzing the aqueous sodium chloride solution to form a halogen gas and the metal base (610).

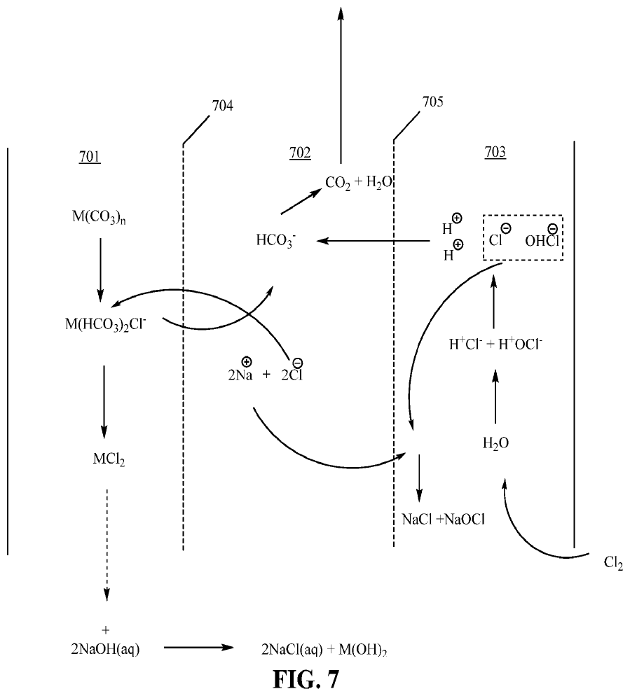

Now referring to FIG. 7, in one embodiment a three-celled reactor is disclosed. The reactor comprises a first chamber 701, a second chamber 702, and a third chamber 703. The first chamber is separated from the second chamber with ion exchange membrane 704, which may be an anion exchange membrane The second chamber is separated from the third chamber with ion exchange membrane 705, which may be a cation exchange membrane. An aqueous metal carbonate solution may be flowed into first chamber 701. An aqueous salt solution, such as a metal halide salt solution, a metal sulfate salt solution, or metal nitrate salt solution, may be flowed into second chamber 702. Third chamber 703 may be filled with water. A halogen gas, such as chlorine gas, may be passed through third chamber 703, which forms halogen water. In another embodiment, halogen water is flowed into third chamber 703.

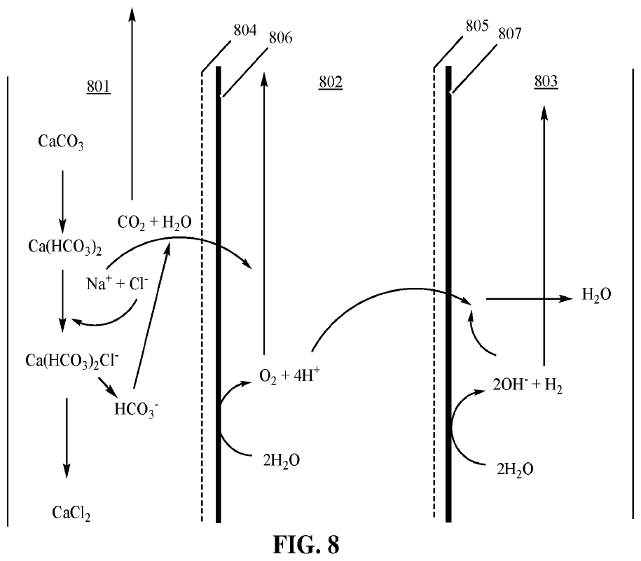

Now referring to FIG. 8, in one embodiment a three-celled reactor is disclosed. The reactor comprises a first chamber 801, a second chamber 802, and a third chamber 803. The first chamber is separated from the second chamber with ion exchange membrane 804, which may be a cation exchange membrane. The second chamber is separated from the third chamber with ion exchange membrane 805, which may be a cation exchange membrane. Second chamber 802 may include anode 806. Third chamber 803 may include cathode 807.

An aqueous metal carbonate solution, such as calcium carbonate, may be flowed into first chamber 801. An aqueous salt solution, such as sodium chloride solution, may also be flowed into first chamber 801. Third chamber 803 may be filled with water.

Water may be reduced at cathode 807 to form hydrogen gas and hydroxide. Water may be oxidized at anode 806 to oxygen gas and H⁺. The hydrolysis of water may drive the formation of a metal halide, such as calcium chloride, from a metal carbonate, such as calcium carbonate, by forming H⁺ which reacts with the carbonate to form carbon dioxide and water.

Although the presently disclosed subject matter and its advantages have been described in detail, it should be understood that various changes, substitutions and alterations can be made herein without departing from the spirit and scope of the disclosed subject matter. Moreover, the scope of the present application is not intended to be limited to the particular embodiments of the process, machine, manufacture, and composition of matter, methods and processes described in the specification. As one of ordinary skill in the art will readily appreciate from the disclosed subject matter of the presently disclosed subject matter, processes, machines, manufacture, compositions of matter, methods, or steps, presently existing or later to be developed that perform substantially the same function or achieve substantially the same result as the corresponding embodiments described herein may be utilized according to the presently disclosed subject matter. Accordingly, the appended claims are intended to include within their scope such processes, machines, manufacture, compositions of matter, methods, or steps.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

1-92. (canceled)

93. A reactor, comprising:
a vessel, wherein the vessel is at least partially filled with water and is configured to receive a halogenated gas;
an inlet fluidly connected to the vessel, wherein the vessel is configured to receive a carbonate through the inlet;
an outlet fluidly connected to the vessel, wherein the outlet is configured to collect a first product of interest from the vessel; and
a gas outlet fluidly connected to the vessel, wherein the gas outlet is configured to release a second product of interest.

94. The reactor of claim 93, further comprising a divider arranged to divide the vessel into a first chamber and a second chamber.

95. The reactor of claim 94, wherein the first chamber is arranged to receive the carbonate through the inlet, and the second chamber is arranged to receive the halogenated gas.

96. The reactor of claim 95, wherein the first chamber is configured to produce the second product of interest, and the gas outlet is fluidly connected to the first chamber.

97. The reactor of claim 95, wherein the first chamber is configured to produce the first product of interest.

98. The reactor of claim 95, wherein the second chamber is configured to produce the first product of interest.

99. The reactor of claim 94, wherein the gas outlet is fluidly connected to a top surface of the first chamber.

100. The reactor of claim 94, wherein the divider is an ion exchange membrane.

101. The reactor of claim 94, wherein the divider is a diaphragm.

102. The reactor of claim 94, wherein the divider is a cation exchange membrane.

103. The reactor of claim 93, wherein the vessel is further configured to receive an alkaline metal salt through the inlet.

104. The reactor of claim 103, wherein the alkaline metal salt is NaCl.

105. The reactor of claim 93, wherein the carbonate is one or more of Li₂CO₃, Na₂CO₃, K₂CO₃, MgCO₃, CaCO₃, SrCO₃, FeCO₃, and BaCO₃.

106. The reactor of claim 93, wherein the halogenated gas is one or more of F₂, Cl₂, Br₂, and I₂.

107. An apparatus for isolating carbon dioxide comprising:
a first chamber containing at least a wet carbonate; and
a second chamber containing an acid, wherein the second chamber is separated from the first chamber by a cation exchange membrane.

108. The apparatus of claim 107, wherein the wet carbonate is one or more of Li₂CO₃, NaHCO₃, Na₂CO₃, K₂CO₃, MgCO₃, CaCO₃, SrCO₃, and BaCO₃.

109. The apparatus of claim 107, wherein the first chamber further contains NaCl.

110. The apparatus of claim 107, wherein the acid comprises water containing a halogen gas.

111. The apparatus of claim 110, wherein the halogen gas is Cl₂.

112. A method comprising:
providing a vessel comprising a first chamber and a second chamber separated by a cation exchange membrane;
providing in the first chamber a first solution, the first solution comprising a metal carbonate;
providing in the second chamber a second solution comprising an acid formed of a halogen in water;
acidifying the first solution by allowing protons from the second solution to pass through the cation exchange membrane; and
forming a salt in the second solution by allowing metal ions from the first solution to pass through the cation exchange membrane and
collecting carbon dioxide from the first chamber.

113. The method of claim 112, wherein the metal carbonate is prepared by contacting a carbon dioxide containing gas to a metal base.
